(19) United States
(12) Patent Application Publication
(10) Pub. No.: US 2022/0309588 A1
(43) Pub. Date: Sep. 29, 2022

(54) IDENTIFYING AND LEVERAGING CLOSE ASSOCIATES FROM UNSTRUCTURED DATA TO IMPROVISE RISK SCORING

(71) Applicant: International Business Machines Corporation, Armonk, NY (US)

(72) Inventors: Ratul Sarkar, Bangalore (IN); Ankit Kumar Singh, Ranchi (IN); Simardeep Singh Arneja, New Delhi (IN); Srinivasan S. Muthuswamy, Ibblur (IN)

(21) Appl. No.: 17/214,173

(22) Filed: Mar. 26, 2021

(51) Int. Cl. G06Q 40/08; G06F 16/23; G06F 16/245; G06N 5/02; G06F 40/205

(52) U.S. Cl. CPC G06Q 40/08; G06F 16/2379; G06F 16/245; G06N 5/022; G06F 40/205

(57) ABSTRACT

A computer implemented method and apparatus receive an element of information via a network interface and analyze the element of information. The method further comprises identifying a related entity to a subject of interest (SOI) based on the analyzing. The method further comprises creating a knowledge graph that represents a relationship between the SOI and the related entity, and determining an overall risk score of the SOI that uses the knowledge graph. An alert may be transmitted, via the network interface, based on the overall risk score.

### BACKGROUND

Disclosed herein is a system and related method for identifying and leveraging close associates from unstructured data to improvise risk scoring. In various situations, obtaining information about a particular subject may be desirable, especially when attempting to obtain information that accurately predicts future behavior of that subject. Obtaining predictive risk information about a particular subject, referred to below as a subject of interest (SOI), may be achieved in various ways.

### SUMMARY

According to some embodiments, computer implemented method is disclosed comprising, using a processor for receiving an element of information via a network interface, analyzing the element of information, and identifying a related entity to a subject of interest (SOI) based on the analyzing. The method further comprises creating a knowledge graph that represents a relationship between the SOI and the related entity, and determining an overall risk score of the SOI that uses the knowledge graph. An alert may be transmitted, via the network interface, based on the overall risk score.

According to some embodiments, a risk determination apparatus comprises a memory and a processor that is configured to receive an element of information via a network interface, analyze the element of information, and identify a related entity to a subject of interest (SOI) based on the analyzing. The apparatus creates a knowledge graph that represents a relationship between the SOI and the related entity, determines an overall risk score of the SOI that uses the knowledge graph, and transmits an alert, via the network interface, based on the overall risk score.

Furthermore, embodiments may take the form of a related computer program product, accessible from a computer-usable or computer-readable medium providing program code for use, by, or in connection, with a computer or any instruction execution system. For the purpose of this description, a computer-usable or computer-readable medium may be any apparatus that may contain a mechanism for storing, communicating, propagating or transporting the program for use, by, or in connection, with the instruction execution system, apparatus, or device.

### BRIEF DESCRIPTION OF THE DRAWINGS

Various embodiments are described herein with reference to different subject-matter. In particular, some embodiments may be described with reference to methods, whereas other embodiments may be described with reference to apparatuses and systems. However, a person skilled in the art will gather from the above and the following description that, unless otherwise notified, in addition to any combination of features belonging to one type of subject-matter, also any combination between features relating to different subject-matter, in particular, between features of the methods, and features of the apparatuses and systems, are considered as to be disclosed within this document.

The aspects defined above, and further aspects disclosed herein, are apparent from the examples of one or more embodiments to be described hereinafter and are explained with reference to the examples of the one or more embodiments, but to which the invention is not limited. Various embodiments are described, by way of example only, and with reference to the following drawings:

FIG. 1A is a block diagram of a data processing system (DPS) according to one or more embodiments disclosed herein.

FIG. 1B is a pictorial diagram that depicts a cloud computing environment according to one or more embodiments disclosed herein.

FIG. 1C is a pictorial diagram that depicts abstraction model layers according to one or more embodiments disclosed herein.

FIG. 2A is a block diagram of a risk scoring system, according to some embodiments.

FIG. 2B is a block flow diagram that illustrates, according to some embodiments, a process for the creation of a knowledge graph.

FIG. 2C is a block flow diagram that illustrates, according to some embodiments, a process for determining an overall risk score for the SOI.

FIG. 3 is a flowchart illustrating an example process that may be used, according to one or more embodiments disclosed herein.

FIGS. 4A-4C are block diagrams illustrating processed input text in various stages, according to some embodiments.

FIG. 5 is a dependency tree illustrating the tree of a sample sentence.

FIG. 6 is a block diagram illustrating flagging a particular case and associated entities if new negative information is found for the associated entity related to the SOI.

### DETAILED DESCRIPTION

The following general computer acronyms may be used below:

TABLE 1
General Computer Acronyms

| | |
|---|---|
| API | application program interface |
| ARM | advanced RISC machine |
| CD- | compact disc ROM |
| ROM | |
| CMS | content management system |
| CoD | capacity on demand |
| CPU | central processing unit |
| CUoD | capacity upgrade on demand |
| DPS | data processing system |
| DVD | digital versatile disk |
| EPROM | erasable programmable read-only memory |
| FPGA | field-programmable gate arrays |
| HA | high availability |
| IaaS | infrastructure as a service |
| I/O | input/output |
| IPL | initial program load |
| ISP | Internet service provider |
| ISA | instruction-set-architecture |
| LAN | local-area network |
| LPAR | logical partition |
| PaaS | platform as a service |
| PDA | personal digital assistant |
| PLA | programmable logic arrays |
| RAM | random access memory |
| RISC | reduced instruction set computer |
| ROM | read-only memory |
| SaaS | software as a service |
| SLA | service level agreement |
| SRAM | static random-access memory |
| WAN | wide-area network |

### Data Processing System in General

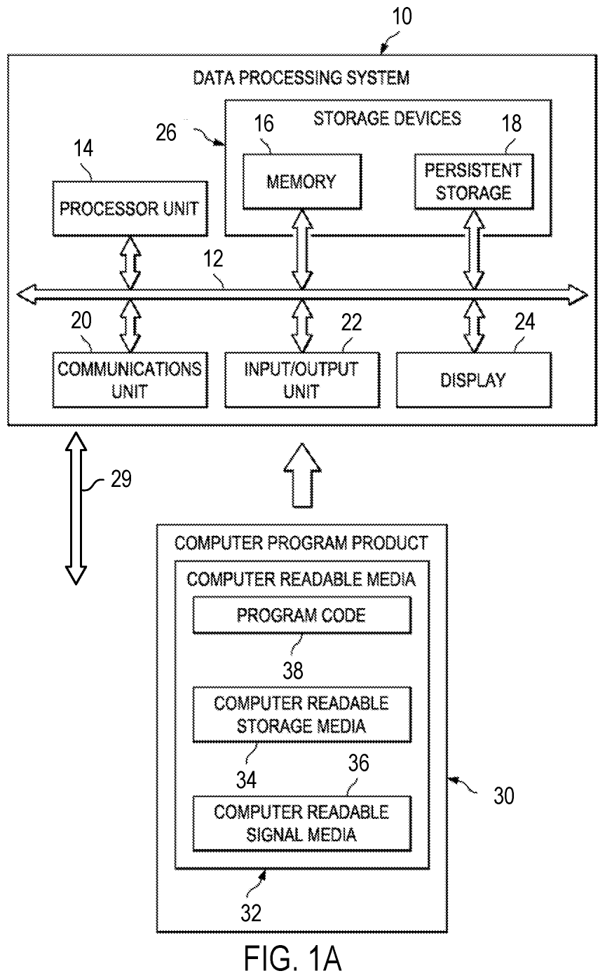

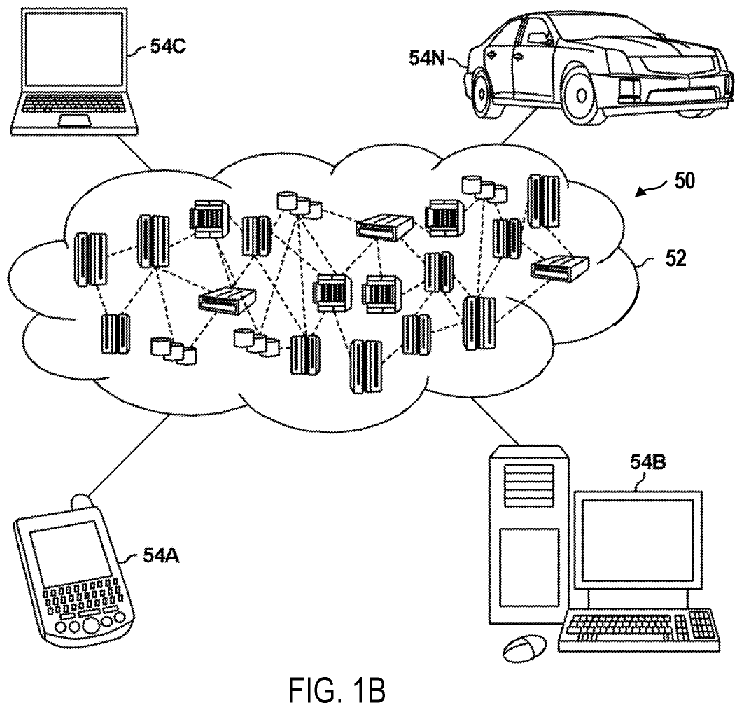

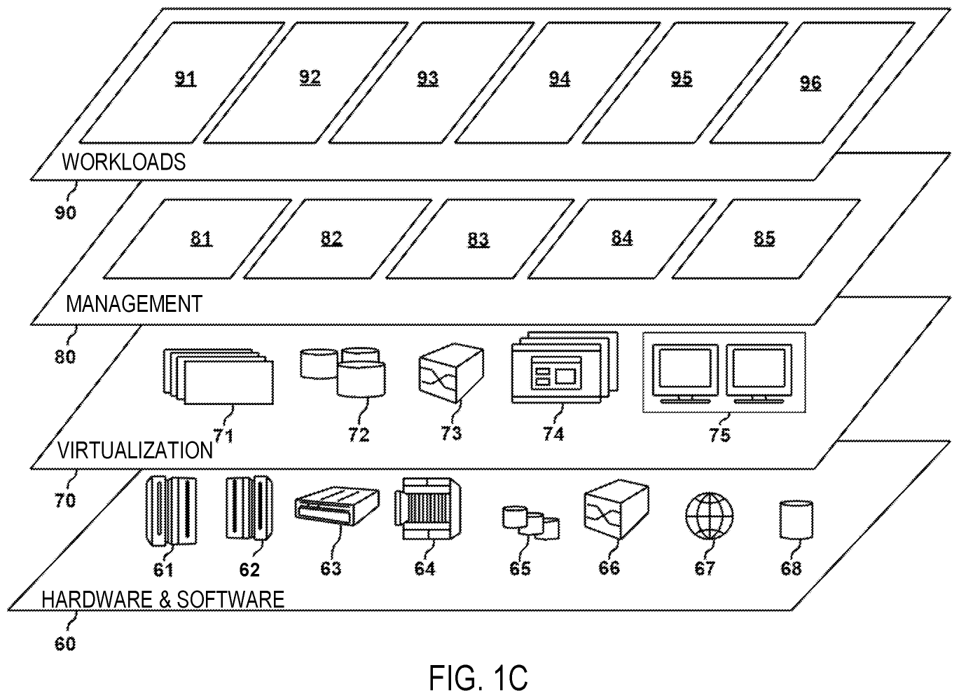

FIG. 1A is a block diagram of an example DPS according to one or more embodiments. In this illustrative example, the DPS 10 may include communications bus 12, which may provide communications between a processor unit 14, a memory 16, persistent storage 18, a communications unit 20, an I/O unit 22, and a display 24.

The processor unit 14 serves to execute instructions for software that may be loaded into the memory 16. The processor unit 14 may be a number of processors, a multi-core processor, or some other type of processor, depending on the particular implementation. A number, as used herein with reference to an item, means one or more items. Further, the processor unit 14 may be implemented using a number of heterogeneous processor systems in which a main processor is present with secondary processors on a single chip. As another illustrative example, the processor unit 14 may be a symmetric multi-processor system containing multiple processors of the same type.

The memory 16 and persistent storage 18 are examples of storage devices 26. A storage device may be any piece of hardware that is capable of storing information, such as, for example without limitation, data, program code in functional form, and/or other suitable information either on a temporary basis and/or a permanent basis. The memory 16, in these examples, may be, for example, a random access memory or any other suitable volatile or non-volatile storage device. The persistent storage 18 may take various forms depending on the particular implementation.

For example, the persistent storage 18 may contain one or more components or devices. For example, the persistent storage 18 may be a hard drive, a flash memory, a rewritable optical disk, a rewritable magnetic tape, or some combination of the above. The media used by the persistent storage 18 also may be removable. For example, a removable hard drive may be used for the persistent storage 18.

The communications unit 20 in these examples may provide for communications with other DPSs or devices. In these examples, the communications unit 20 is a network interface card. The communications unit 20 may provide communications through the use of either or both physical and wireless communications links.

The input/output unit 22 may allow for input and output of data with other devices that may be connected to the DPS 10. For example, the input/output unit 22 may provide a connection for user input through a keyboard, a mouse, and/or some other suitable input device. Further, the input/output unit 22 may send output to a printer. The display 24 may provide a mechanism to display information to a user.

Instructions for the operating system, applications and/or programs may be located in the storage devices 26, which are in communication with the processor unit 14 through the communications bus 12. In these illustrative examples, the instructions are in a functional form on the persistent storage 18. These instructions may be loaded into the memory 16 for execution by the processor unit 14. The processes of the different embodiments may be performed by the processor unit 14 using computer implemented instructions, which may be located in a memory, such as the memory 16. These instructions are referred to as program code 38 (described below) computer usable program code, or computer readable program code that may be read and executed by a processor in the processor unit 14. The program code in the different embodiments may be embodied on different physical or tangible computer readable media, such as the memory 16 or the persistent storage 18.

The DPS 10 may further comprise an interface for a network 29. The interface may include hardware, drivers, software, and the like to allow communications over wired and wireless networks 29 and may implement any number of communication protocols, including those, for example, at various levels of the Open Systems Interconnection (OSI) seven layer model.

FIG. 1A further illustrates a computer program product 30 that may contain the program code 38. The program code 38 may be located in a functional form on the computer readable media 32 that is selectively removable and may be loaded onto or transferred to the DPS 10 for execution by the processor unit 14. The program code 38 and computer readable media 32 may form a computer program product 30 in these examples. In one example, the computer readable media 32 may be computer readable storage media 34 or computer readable signal media 36. Computer readable storage media 34 may include, for example, an optical or magnetic disk that is inserted or placed into a drive or other device that is part of the persistent storage 18 for transfer onto a storage device, such as a hard drive, that is part of the persistent storage 18. The computer readable storage media 34 also may take the form of a persistent storage, such as a hard drive, a thumb drive, or a flash memory, that is connected to the DPS 10. In some instances, the computer readable storage media 34 may not be removable from the DPS 10.

Alternatively, the program code 38 may be transferred to the DPS 10 using the computer readable signal media 36. The computer readable signal media 36 may be, for example, a propagated data signal containing the program code 38. For example, the computer readable signal media 36 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, the program code 38 may be downloaded over a network to the persistent storage 18 from another device or DPS through the computer readable signal media 36 for use within the DPS 10. For instance, program code stored in a computer readable storage medium in a server DPS may be downloaded over a network from the server to the DPS 10. The DPS providing the program code 38 may be a server computer, a client computer, or some other device capable of storing and transmitting the program code 38.

The different components illustrated for the DPS 10 are not meant to provide architectural limitations to the manner in which different embodiments may be implemented. The different illustrative embodiments may be implemented in a DPS including components in addition to or in place of those illustrated for the DPS 10.

### Cloud Computing in General

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 1B, illustrative cloud computing environment 52 is depicted. As shown, cloud computing environment 52 includes one or more cloud computing nodes 50 with which local computing devices used by cloud consumers, such as, for example, personal digital assistant (PDA) or cellular telephone 54A, desktop computer 54B, laptop computer 54C, and/or automobile computer system 54N may communicate. Nodes 50 may communicate with one another. They may be grouped (not shown) physically or virtually, in one or more networks, such as Private, Community, Public, or Hybrid clouds as described hereinabove, or a combination thereof. This allows cloud computing environment 52 to offer infrastructure, platforms and/or software as services for which a cloud consumer does not need to maintain resources on a local computing device. It is understood that the types of computing devices 54A-N shown in FIG. 1B are intended to be illustrative only and that computing nodes 50 and cloud computing environment 52 can communicate with any type of computerized device over any type of network and/or network addressable connection (e.g., using a web browser).

Referring now to FIG. 1C, a set of functional abstraction layers provided by cloud computing environment 52 (FIG. 1B) is shown. It should be understood in advance that the components, layers, and functions shown in FIG. 1C are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and application processing 96.

Any of the nodes 50 in the computing environment 52 as well as the computing devices 54A-N may be a DPS 10.

### Computer Readable Media

The present invention may be a system, a method, and/or a computer readable media at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Technical Application

The one or more embodiments disclosed herein accordingly provide an improvement to computer technology. For example, an improvement to a risk scoring mechanism allows for a more efficient and effective risk determination to be made with respect to entities that allows greater flexibility and security.

### Using Unstructured Data to Improvise Scoring

The following application specific acronyms may be used below:

TABLE 2
Application Specific Acronyms

| | |
|---|---|
| CA | close associate |
| CCA | candidate close associate |
| KYC | know your customer [process] |
| SOI | subject of interest |

Obtaining predictive information about an SOI in order to predict future behavior or circumstances related to the SOI may be desirable in certain situations. For example, banks and insurance companies, during a “know your customer” (KYC) process, may look at both structured and unstructured data as a part of a customer identification and verification process. Structured data may be defined as data that are highly organized and formatted in a way so that the data is easily searchable, whereas unstructured data may be defined as data having no pre-defined format. The KYC process ascertains information pertinent for doing financial business with the customers. As part of the information gathering and analysis process, articles are ranked from unstructured sources (e.g., news articles, on-line posts, etc.) to make investigators aware of the content of unstructured information received from the unstructured sources. This unstructured information may include, for example, relevant top news, including top adverse news or other adverse/negative information, such as adverse press information and other negative news on an entity. We provide scores based on negativity of the articles, so we will annotate the negative part in the articles although it may have both good and negative info. Often, such unstructured sources reveal close entities, relationships, and details that are not provided or disclosed by the SOI (e.g., during the KYC process), and such details may not necessarily be ascertained from structured sources.

In some embodiments, the system and method disclosed herein helps investigators, such as banks, to rank negative information based on a relevance of data and effectiveness of the source information, such as articles (unstructured data), to the SOI in search, as well as available structured sources. In the event that related entities have a low or medium risk, such entities may be kept in a watchlist. An entity that is in the watchlist may be monitored for negative information as well as its related entries obtained from the respective information sources.

This will help the analyst or investigator to dynamically monitor the risk from negative news due to the entity's involvement or its closely related associates that were identified from the unstructured news articles. This solution may impact, e.g., entities dealing with third party distributors/contractors. The present disclosure provides a mechanism to extract such close entities from the unstructured sources and further study the related entities in order to produce an overall risk score of the SOI and apply it.

In order to achieve this, the SOI related entities (e.g., the closely associated entities) may be determined for the given SOI from unstructured information sources, and negative news events are monitored for both the SOI and the SOI related entities. The unstructured sources of information (e.g., news articles, documents, court proceedings, etc.) may be analyzed and identify the SOI related entities may be identified from this. A knowledge graph may then be created that represents the relationship between the SOI and the SOI related entities. From this, an overall risk score of the SOI may be computed using the knowledge graph.

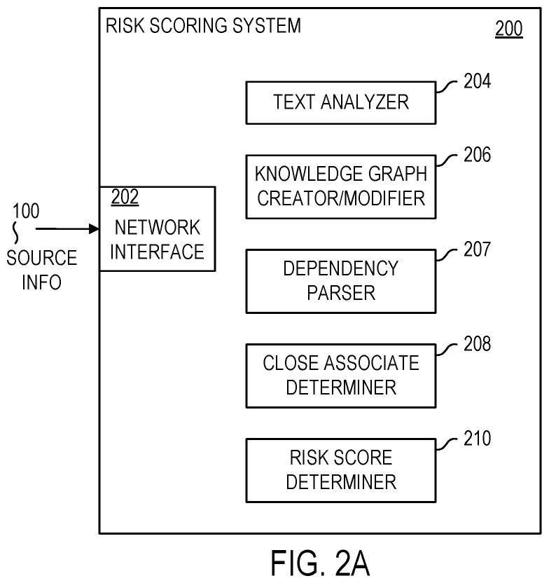

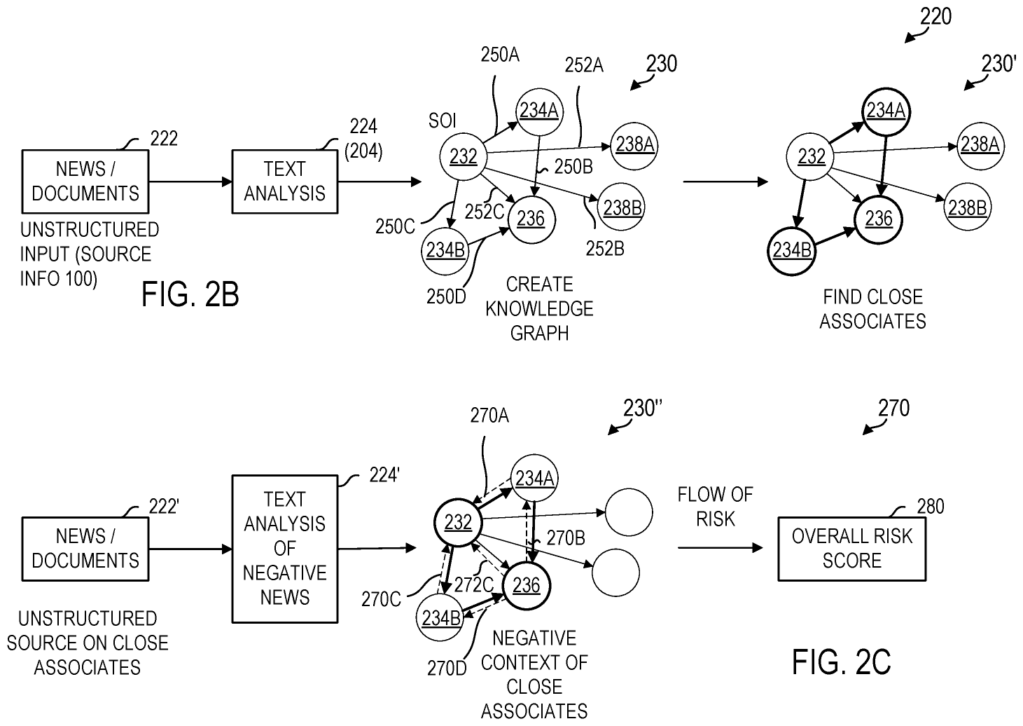

FIG. 2A is a block diagram of a risk scoring system 200, according to some embodiments. The risk scoring system 200 may execute on, e.g., a DPS 10, and operate within a cloud architecture, such as on a node 50 of the computing environment 52 described above. The risk scoring system 200 may constitute the application processing 96 within such an architecture. The risk scoring system 200 may comprise a network interface 202 via which source information (structured or unstructured) 100 may be provided to the system 200. The source information 100 may be processed by a text analyzer 204 in order to provide additional structure that may be used in subsequent processing. Output from the text analyzer 204 may be used to create or modify a knowledge graph by the knowledge graph creator/modifier 206. Using analyzed text information and knowledge graph, a close associate determiner 208 may determine close associates to the SOI, and the risk score determiner 210 may determine the risk score for the SOI. These elements are discussed in more detail below.

FIG. 2B is a block flow diagram that illustrates, according to some embodiments, a process 220 for the creation of a knowledge graph 230 on various entities (individual/organization) (234A-238B) associated with the SOI 232. The source information 100, e.g., in the form of news or other documents 222 as unstructured input, may be provided for text analysis 224 by the text analyzer 204 from which a knowledge graph 230 is created with respect to the SOI 232 (the text analysis 224 is described in more detail below). The knowledge graph 230 is shown, by way of example, in a first state in which five entities are shown 234A, 234B, 236, 238A, 238B with respect to the SOI 232 (shown in a bolded circle). Relationships between the entities 232-238B are depicted by arrows 250A, 250B, 250C, 250D, 252A, 252B, 252C (referred to by numeric portion only (250, 252) in a collective or representative manner). These relationships may be single values, vectors, or other variables/aggregates that characterize the relationship between the entities.

The graph 230 is created by the knowledge graph creator/modifier 206 to determine the relationships 250, 252 between the entities 232-238B. These relationships may be established based on correlations of words and phrases and their relationships to one another from the text analysis 224. For example, a relationship between the SOI 232 (x) and an entity 236 (y) could be established if the phrase “x and y are competitors in that market for telecommunication services”. A revised knowledge graph 230′ may be determined by the close associate determiner 208 that highlights close associates 234A, 234B to the SOI 232. The determination of close associates may be made in any number of ways. For example, a close associate may be determined from particular language found based on the text analysis 224, e.g., a close associate could be determined if the phrase “z (234A) is a wholly owned subsidiary of x (232)”. A wholly owned subsidiary suggests a much closer relationship than mere competitors, and thus, based on the close associate determiner 208 utilizing various thresholds, various entities (234A, 234B) illustrated as bolded in the revised knowledge graph 230′, are designated as close associates of the SOI 232.

FIG. 2C is a block flow diagram that illustrates, according to some embodiments, a process 270 for determining an overall risk score 280 for the SOI 232. Here, source information 100, e.g., in the form of news or other documents 222′ may be obtained and processed, as in the process 220 shown in FIG. 2B. However, unlike in FIG. 2B, this source information 100 relates to the close associates 234A, 234B that were previously identified by the close associate determiner 208. Similarly, the process 270 of FIG. 2C differs from the process 220 of FIG. 2B in that the text analysis 224′ focuses on negative news associated with the close associates 234A, 234B. The risk score determiner 210 then applies the text analysis of the negative news 224′ to the graph 230″ which may be used to adjust the relationships 270A, 270B, 270C, 270D (collectively or representatively 270, and representing a flow of risk) and any associated values. The bold arrows here represent a high degree of association with the SOI or a primary entity, and the thin arrows represent a low degree of association. Based on a formula applied to the relationship values 270, the risk score determiner may determine an overall risk score 280 for the SOI 232. The formula may be, e.g., a weighted average based on the negative news risk score and degree of association.

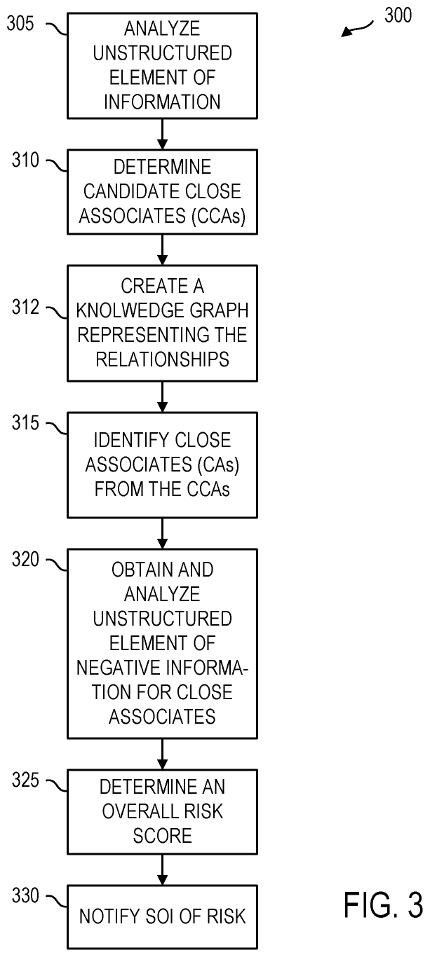

FIG. 3 is a flowchart that illustrates an example process 300 that may be used by the risk scoring system 200, according to some embodiments. The production of the graphs 230, 230′ may involve the use of the knowledge graph creator/modifier 206, and the close associate determiner 208. Although operations involving these entities are shown as operating sequentially in FIG. 3, the operations may operate in parallel to some extent. For example, a flagging of certain entities as relevant may occur prior to the entire text being analyzed by the text analyzer 204. In some embodiments, this may be performed by the text analyzer 204 making multiple passes through the received unstructured text.

In operation 305, the text analyzer 204 may receive, e.g., an unstructured element of information from a network interface 202 in order to determine related entities 232-238 and the relationships 250, 252 between them.

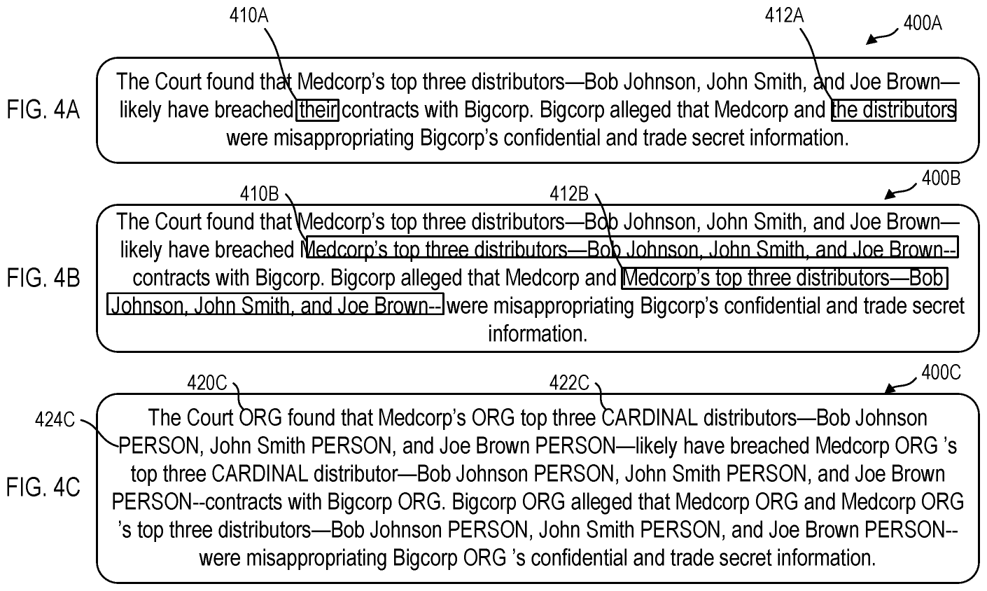

FIGS. 4A-4C are block diagrams illustrating processed input text 400A, 400B, 400C, in various stages, according to some embodiments. Referring to FIG. 4A, unstructured input text 400A in the form of the content of an article, by way of example, is received by the risk scoring system 200 in operation 305. The text analyzer 204 may resolve co-references and identify all text units (which may be, in some instances, in the form of sentences) that contains the SOI 232. The SOI 232 may have been previously identified to the risk scoring system 200, or may be identified in some other way, as an input variable in the system. For example, a bank analyst or an investigator may raise a case/investigation on an entity while onboarding them.

This resolution may involve resolving the co-reference in the information item content so that text units referring to the SOI 232 or its related entities will contain a name instead of a pronoun.

By way of the illustrated example, the text analyzer 204 may identify, as entities related to the SOI entity Medcorp, Bob Johnson, John Smith, and Joe Brown. In this example, the relationship may be identified by the text indicating that these latter entities are distributors of Medcorp, which suggests a close association. As can be seen, the SOI 232 in the example illustration is Medcorp, and the pronoun “their” 410A has been flagged for replacement with actual names. Similarly, the generic term “the distributors” 412A is also flagged for replacement by the actual names of the distributor entities.

FIG. 4B is a block diagram illustrating the input text 400B after resolving the co-references. As can be seen, the pronoun “their” 410A has been replaced with actual names “Medcorp's top three distributors—Bob Johnson, John Smith, and Joe Brown” 410B. Similarly, “the distributors” 412A has been replaced with “Medcorp's top three distributors—Bob Johnson, John Smith, and Joe Brown” 412B. The text analyzer 204 may further identify text units containing the SOI 232 for further investigation.

Following this, operation 305 may comprise using the identified text units to extract all entities labeled in a particular manner, for example, those labeled as a company or person, from each text unit. As shown in FIG. 4C, all entities may be extracted and labeled by the text analyzer 204 as an “organization” 420C, a “cardinal” 422C, a “person” 424C, or tagged in any other way from the identified text units above. The input text 400C has had the named entities labeled accordingly. For the text analyzer, a pre-trained language model (e.g., NER—Named Entity Recognizer functionality) and use transfer learning paradigm that classifies named entities available in the sentences may be used.

In operation 310, the extracted entities may be utilized as a list of candidate close associates (CCAs) 234-238 of the SOI 232. The knowledge graph creator/modifier 206 creates a graph 230 containing identified entities 234-238 that may relate to the SOI 232.

In operation 312, the knowledge graph 230 is created that represents the CCAs 234-238 and their respective relationships 250, 252. To determine these relationships, the dependency parser 207 may be employed to analyze the text unit to determine the nature and weighting of the associations between the entities.

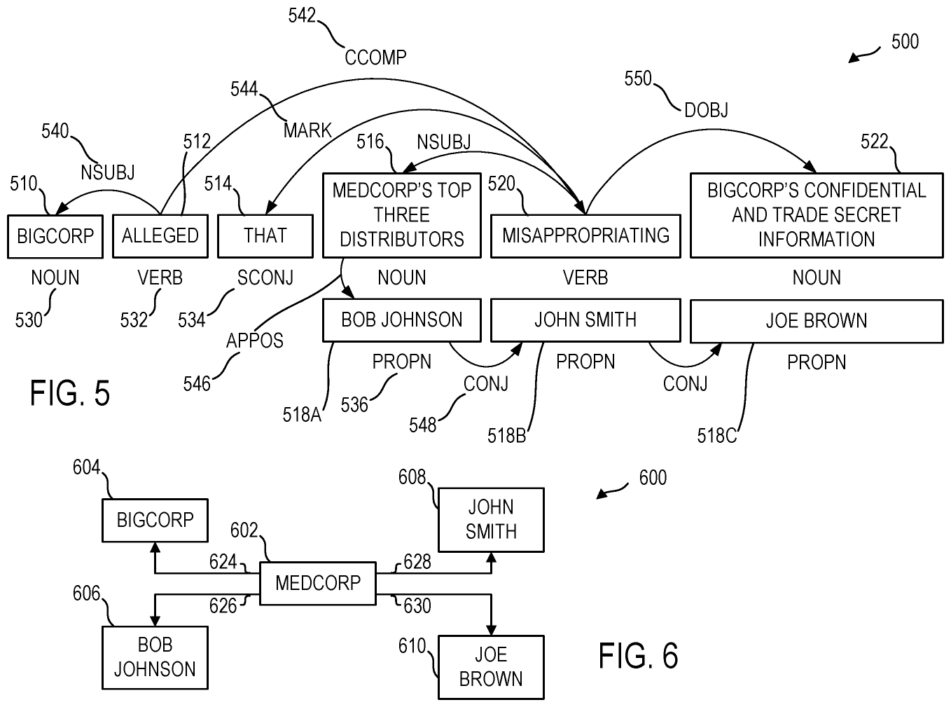

FIG. 5 illustrates an example dependency tree 500 produced by the dependency parser 207 for the labeled input text 400C. The object “Bigcorp” 510 has been identified as a noun 530, and the verb 532 “alleged” 512 has been identified as applying to the noun subject 540. The verb “misappropriating” 520 has been identified as applying to the noun subject “Medcorp's top three distributors” 516 as a noun. These distributors 516 are identified by the appositives 546, which are all proper nouns 536, “Bob Johnson” 518A, “John Smith” 518B, and “Joe Brown” 518C, each connected with conjunctions 548. The word “that” 514 serves as an infinitive marker 544 related to the verb “misappropriating” 520, and the nouns “Bigcorp's confidential and trade secret information” 522 serving as the direct object 550 for the “misappropriating” 520. The dependency parser 207 may identify terms, such as “distributors”, “misappropriating”, “contracts”, “trade secret information” and “breached” in the present example, and use them in the determination of the relationship values 250, 252 between the entities 232-238.

The parts of speech, entities, and their relationships, as shown for example in FIG. 5, are then used to construct the graph 230. FIG. 6 is a graph 600 that is specific to the example used in FIGS. 4A-5. The Medcorp 602 entity, as the SOI, serves as a focal point for the graph, and its relationship to Bigcorp 604, as well as its top three distributors Bob Johnson 606, John Smith 608, and Joe Brown 610. The arrows illustrate the respective relationships 624, 626, 628, 630. The dependency parser 207 may be used to identify associations of each of the CCAs 234-238 with the SOI 232, and then assign an association weight and/or values 250, 252 to each of the CCAs for their direct or indirect association with the SOI 232. These CCAs may be filtered with the higher association weight as new candidates—in the example shown, this is Bigcorp, Bob Johnson, John Smith, and Joe Brown.

In operation 315, the close associate determiner 208 identifies the close associates 234 of the SOI 232, based on a set of predefined rules or criteria. A corresponding knowledge graph 230′ may include an indication or identification of the CCAs 234-238. The close associate determiner 208 may analyze the knowledge graph 230, looking primarily at the relationships 250, 252 between the SOI 232 and CCAs to determine the closeness of the association between them. To find the close associates (CAs) from the CCAs, semantic meaning, frequency of co-occurrence with the SOI 232, and other techniques may be utilized, in addition to a threshold value(s), characteristics, test, or other determination. For example, the close associate determiner 208 may filter out entities having a low frequency of occurrence, according to some predefined threshold or other criteria.

In addition, the semantic meaning of various phrases may be determined as positive or negative. By way of example, the terms “misappropriating” and “breached” may be construed as having a negative semantic meaning. A filtering may be performed such that only negatively associated entities remain. This may be done by either looking solely at negative language and relationships, or by removing positive entities or those entities that might portray an entity as a bad performer. As shown in FIG. 2B, after this filtering process, the SOI's 232 CAs are shown designated as 234A and 234B.

In operation 320, and once the CAs 234A, 234B are established, additional information may be obtained related to them. This may be based on further queries to unstructured text already received, or it may be based on further searches expressly using information about the CAs 234A, 234B. The unstructured source 222′ may be put through a similar process (text analysis of negative news 224′) and filtering as described above, and the graph may be updated accordingly, resulting in the graph 230″. The associations 250 related to the close associates may be adjusted 270A, 270B, 270C, 270D based on the text analysis of the negative news 224′. The text analysis for negative news 224′ for the unstructured information related to the close associates 234 is performed and a further modification of the graph 230″ may incorporate adjustments of the relationships 270.

In operation 325, an overall risk score 280 may be calculated with the risk score determiner 210 for the SOI 232 based on the further modified graph 230″, which may be calculated using information in the relationships 270. Furthermore, risk scores for the close associates 234 may be determined as well and flagged in a manner similar to the risk score of the SOI. Thus, the risk score for all the entities (the SOI 232 as well as the CAs 234) may be calculated based on few categorical scores and then calculating the overall score which is based on risk score weighted by a degree of association The risk score of each CA 234 is determined, and, if it rises to the level of an alarming threshold, operation 330 may then find the article(s) or information/sources causing the alarm. If the article(s) or other information is further related to the SOI 232, then operation 330 may raise an alert in the system notifying the SOI 232, the related entity(s), and the author, copyright holder, manager, or database maintainer associated with the information source. The alarm may thus be utilized, by way of example, for bank customers (e.g., initial loans or refinancing) or an institutional onboarding process.

What is claimed is:

1. A computer implemented method comprising, using a processor:
receiving an element of information via a network interface;
analyzing the element of information;
identifying a related entity to a subject of interest (SOI) based on the analyzing;
creating a knowledge graph that represents a relationship between the SOI and the related entity;
determining an overall risk score of the SOI that uses the knowledge graph; and
transmitting an alert, via the network interface, based on the overall risk score.

2. The method of claim 1, wherein the related entity comprises a plurality of related entities that are candidate close associates (CCAs).

3. The method of claim 2, further comprising:
determining close associates (CAs) from the CCAs using a CA determiner that utilizes a predefined set of rules or criteria.

4. The method of claim 3, further comprising determining risk scores for the CAs.

5. The method of claim 4, further comprising:
obtaining information contributing to a CA risk score exceeding a predefined threshold; and
sending the obtained information to at least one of the SOI or the CAs.

6. The method of claim 3, further comprising:
applying a filtering to the CAs so that only negatively associated CAs remain.

7. The method of claim 6, wherein applying the filtering is performed by determining phrases of the elements of information as having a negative semantic meaning.

8. The method of claim 6, wherein applying the filtering is performed by:
determining phrases of the elements of information as having a positive semantic meaning or interpreting entities as bad performers.

9. The method of claim 6, further comprising:
obtaining additional elements of information related to the remaining CAs;
further analyzing the additional elements of information; and
updating the knowledge graph based on the further analysis.

10. The method of claim 9, further comprising:
performing a further search to obtain the additional elements of information.

11. The method of claim 9, wherein the updating of the knowledge graph comprises adjusting associations related to the CAs.

12. The method of claim 2, wherein a text analyzer parses the element of information by:
replacing pronouns with entity names; and
labelling entities in the element of information.

13. The method of claim 12:
wherein the labelling of the entities comprises adding labels that include “organization” and “person”; and
the method further comprises using a list of the extracted entities as the CCAs.

14. The method of claim 2, further comprising assigning a weighting between the SOI and the CCAs, and between the CCAs.

15. The method of claim 1, wherein the element of information is an unstructured element of information.

16. The method of claim 1, wherein the identifying of the related entity comprises replacing pronouns with names in the element of information.

17. A risk determination apparatus, comprising:
a memory; and
a processor that is configured to:
receive an element of information via a network interface;
analyze the element of information;
identify a related entity to a subject of interest (SOI) based on the analyzing;
create a knowledge graph that represents a relationship between the SOI and the related entity;
determine an overall risk score of the SOI that uses the knowledge graph; and
transmit an alert, via the network interface, based on the overall risk score.

18. The apparatus of claim 17, wherein:
the related entity comprises a plurality of related entities that are candidate close associates (CCAs);
the processor is further configured to:
determine close associates (CAs) from the CCAs using a CA determiner that utilizes a predefined set of rules or criteria;
determine risk scores for the CAs;
obtain information contributing to a CA risk score exceeding a predefined threshold;
send the obtained information to at least one of the SOI or the CAs;
apply a filtering to the CAs so that only negatively associated CAs remain, wherein applying the filtering is performed by determining phrases of the elements of information as having a negative semantic meaning;
obtain additional elements of information related to the remaining CAs;
further analyze the additional elements of information; and
update the knowledge graph based on the further analysis.

19. A computer program product for risk determination, the computer program product comprising:
one or more computer readable storage media, and program instructions collectively stored on the one or more computer readable storage media, the program instructions comprising program instructions to:
receive an element of information via a network interface;
the element of information;
identify a related entity to a subject of interest (SOI) based on the analyzing;
create a knowledge graph that represents a relationship between the SOI and the related entity;
determine an overall risk score of the SOI that uses the knowledge graph; and
transmit an alert, via the network interface, based on the overall risk score.

20. The computer program product of claim 19, wherein:
the related entity comprises a plurality of related entities that are candidate close associates (CCAs);
the program instructions further configure the processor to:
determine close associates (CAs) from the CCAs using a CA determiner that utilizes a predefined set of rules or criteria;
determine risk scores for the CAs;
obtain information contributing to a CA risk score exceeding a predefined threshold;
send the obtained information to at least one of the SOI or the CAs;
apply a filtering to the CAs so that only negatively associated CAs remain, wherein applying the filtering is performed by determining phrases of the elements of information as having a negative semantic meaning;
obtain additional elements of information related to the remaining CAs;
further analyze the additional elements of information;
update the knowledge graph based on the further analysis;
perform a further search to obtain the additional elements of information;
wherein:
the updating of the knowledge graph comprises adjusting associations related to the CAs;
the program instructions further cause the processor to perform the updating using:
a text analyzer that parses the element of information using the program instructions to:
replace pronouns with entity names; and
label entities in the element of information;
wherein:
the labelling of the entities comprises adding labels that include “organization” and “person”;
the program instructions further configure the processor to:
use a list of the extracted entities as the CCAs;
assign a weighting between the SOI and the CCAs, and between the CCAs;
the element of information is an unstructured element of information; and
the identifying of the related entity comprises replacing pronouns with names in the element of information.
